(19) United States
(12) Patent Application Publication
(10) Pub. No.: US 2019/0099841 A1
(43) Pub. Date: Apr. 4, 2019

(54) ALUMINUM ALLOY MATERIAL FOR HEAT EXCHANGER AND METHOD FOR MANUFACTURING SAME, AND ALUMINUM ALLOY CLAD MATERIAL FOR HEAT EXCHANGER AND METHOD FOR MANUFACTURING SAME

(71) Applicant: UACJ Corporation, Tokyo (JP)

(72) Inventors: Wataru NARITA, Tokyo (JP); Atsushi FUKUMOTO, Tokyo (JP)

(21) Appl. No.: 16/086,913

(22) PCT Filed: Mar. 23, 2017
(86) PCT No.: PCT/JP2017/011618

§ 371 Date: Sep. 20, 2018

(30) Foreign Application Priority Data
Mar. 24, 2016 (JP) 2016-059597

(51) Int. Cl. B23K 35/28; C22C 21/14; C22C 21/16; C22F 1/057

(52) U.S. Cl. CPC B23K 35/286; C22C 21/14; B23K 2101/14; C22F 1/057; C22C 21/16

(57) ABSTRACT

Provided are: an aluminum alloy material for a heat exchanger, including an aluminum alloy including 0.02 to 0.40 mass % Si, 1.0 to 2.5 mass % Cu, 0.5 to 2.0 mass % Mn, and a balance of Al and inevitable impurities, in which the number density of an Al—Cu—Mn-based intermetallic compound having an equivalent circle diameter of 0.1 to 1.0 μm is 1.0×10⁶/mm² or more; and a method for producing the aluminum alloy material.

### TECHNICAL FIELD

The present disclosure relates to a high-strength aluminum alloy material for a heat exchanger, which is preferably used as a passage structural material for a refrigerant and high-temperature compressed air in a heat exchanger such as a radiator, a method for producing the aluminum alloy material, an aluminum alloy clad material for a heat exchanger, and a method for producing the aluminum alloy clad material.

### BACKGROUND ART

For example, as illustrated in FIG. 1, a heat exchanger such as a radiator has a structure in which a thin-walled fin 2 worked in a corrugated shape is arranged between plural tubes 1 formed in a flat shape. The tubes 1 and the fin 2 are bonded to each other by brazing. Both ends of the tubes 1 is opened to spaces, respectively, configured by headers 3 and tanks 4. In the heat exchanger, a high-temperature refrigerant is fed from one tank to the other tank through the tubes 1 and subjected to heat exchange by the tubes 1 and the fin 2, and the refrigerant at a low temperature is circulated.

A brazing sheet including a core material, an internal pasting material having a sacrificial anode effect, and a brazing filler material is typically used in a tube in such a heat exchanger. For example, a JIS 3003 (Al-0.15 mass % Cu-1.1 mass % Mn) alloy is used as the core material. As the internal pasting material, a JIS 7072 (Al-1 mass % Zn) alloy is used on the inside of the core material, that is, a side that always comes into contact with a refrigerant. As the brazing filler material, a JIS 4045 (Al-10 mass % Si) alloy or the like is typically used on the outside of the core material. The tube is bonded integrally with other members such as a fin worked in a corrugated shape, by brazing. Examples of brazing methods include a flux brazing method and a Nocolok brazing method using a noncorrosive flux. The brazing is performed by heating each member to a temperature of around 600° C.

In recent years, reductions in the thicknesses of aluminum materials for tubes have been demanded for reducing the weights of heat exchangers, whereby higher strength has been demanded. There have been conventionally material design concepts about higher strength that primarily, Al—Si—Mn-based precipitates are finely dispersed, and materials are strengthened by dispersion strengthening. Thus, a method of increasing the content of Si in a core material has been used for higher strength. However, a melting point is greatly decreased by increasing the content Si in a core material. In brazing, heating is performed to a temperature of around 600° C. Therefore, a great increase in the content of Si is undesirable because of being prone to result in melting of a material, in consideration of variations in the temperature of the interior of a furnace. Therefore, the higher strengths of tube materials have been in the state of peaking out.

In contrast, Patent Literature 1 describes a brazing sheet in which one surface of a core material containing Cu is clad with a sacrificial anode material containing Zn and Mg. Although strength is increased by dispersing Al—Cu—Mg—Zn-based precipitates in a portion from an interface between the sacrificial anode material and the core material in the brazing sheet into the core material at a depth of 30 μm, the effect of improving the strength in an overall tube material is small.

Patent Literature 2 describes a brazing sheet made of an aluminum alloy, in which the amount of Cu solid solution after brazing heating is increased by increasing the content of Cu in a core material, and Mg diffused from a sacrificial anode material promotes the aging precipitation of Mg/Si in the core material to improve strength after the brazing heating. However, since the addition of a large amount of Cu to the core material causes Mn and a compound to be generated, thereby precipitating an Al—Cu—Mn-based compound, it may be impossible to obtain high strength after brazing heating even if a large amount of Cu is contained in the core material.

### CITATION LIST

### Patent Literature

Patent Literature 1: Japanese Patent Application Publication No. H9-95749

Patent Literature 2: Japanese Patent Application Publication No. 2015-190045

### SUMMARY OF INVENTION

### Technical Problem

The present disclosure was made in view of the problems described above, with an objective of providing an aluminum alloy material for a heat exchanger exhibiting high strength after brazing heating, a method for producing the aluminum alloy material, an aluminum alloy clad material for a heat exchanger, and a method for producing the aluminum alloy clad material.

### Solution to Problem

To solve the problems described above, the present inventors found that the utmost use of precipitation strengthening and solid solution strengthening after brazing heating is enabled, and an aluminum alloy material exhibiting high strength can be obtained by defining the state of the presence of an Al—Cu—Mn-based intermetallic compound.

In the first disclosure, claim 1 is an aluminum alloy material for a heat exchanger, including an aluminum alloy including 0.02 to 0.40 mass % Si, 1.0 to 2.5 mass % Cu, 0.5 to 2.0 mass % Mn, and the balance of Al and inevitable impurities, wherein the number density of an Al—Cu—Mn-based intermetallic compound having an equivalent circle diameter of 0.1 to 1.0 μm is 1.0×10⁶ particles/mm² or more.

In claim 2 in the present disclosure, the aluminum alloy further includes one or more selected from 0.1 to 1.0 mass % Mg, 0.05 to 0.20 mass % Ti, 0.05 to 0.20 mass % V, 0.05 to 0.20 mass % Zr, and 0.05 to 0.20 mass % Cr, in claim 1.

In the present disclosure, claim 3 is a method for producing the aluminum alloy material for a heat exchanger according to claim 1 or 2, the method including a casting step of casting the aluminum alloy, a hot-rolling step of hot-rolling a cast ingot, a cold-rolling step of cold-rolling a hot-rolled sheet, and one or more annealing steps of annealing a cold-rolled sheet during or after the cold-rolling step, or during and after the cold-rolling step, wherein a sheet thickness reduction ratio in a case in which the temperature of the hot-rolled sheet is in a temperature range of 500 to 400° C. is 90% or more in the hot-rolling step.

In Embodiment 1 in the second disclosure, claim 4 is an aluminum alloy clad material for a heat exchanger, including: a core material of an aluminum alloy; and a brazing filler material clad on one surface or both surfaces of the core material, wherein the core material includes an aluminum alloy including 0.02 to 0.40 mass % Si, 1.0 to 2.5 mass % Cu, 0.5 to 2.0 mass % Mn, and the balance of Al and inevitable impurities; the brazing filler material includes an aluminum alloy including 2.5 to 12.5 mass % Si, 0.05 to 1.20 mass % Fe, and the balance of Al and inevitable impurities; and the number density of an Al—Cu—Mn-based intermetallic compound having an equivalent circle diameter of 0.1 to 1.0 μm in the core material is 1.0×10⁶ particles/mm² or more.

In claim 5 in the present disclosure, the core material further includes one or more selected from 0.1 to 1.0 mass % Mg, 0.05 to 0.20 mass % Ti, 0.05 to 0.20 mass % V, 0.05 to 0.20 mass % Zr, and 0.05 to 0.20 mass % Cr, in claim 4.

In claim 6 in the present disclosure, the brazing filler material includes an aluminum alloy further including one or more selected from 0.5 to 8.0 mass % Zn, 0.05 to 2.50 mass % Cu, 0.05 to 2.00 mass % Mn, 0.05 to 0.20 mass % Ti, 0.05 to 0.20 mass % Zr, 0.05 to 0.20 mass % Cr, and 0.05 to 0.20 mass % V, in claim 4 or 5.

In claim 7 in the present disclosure, the brazing filler material includes an aluminum alloy further including one or two selected from 0.001 to 0.050 mass % Na and 0.001 to 0.050 mass % Sr, in any one of claims 4 to 6.

In the present disclosure, claim 8 is a method for producing the aluminum alloy clad material for a heat exchanger according to any one of claims 4 to 7, the method including: a casting step of casting each of the aluminum alloy for the core material and the aluminum alloy for the brazing filler material; a hot-rolling step of hot-rolling a cast brazing filler material ingot to have a predetermined thickness; a cladding step of cladding the brazing filler material allowed to have the predetermined thickness by the hot rolling on one surface or both surfaces of a core material ingot; a hot clad rolling step of hot-rolling the clad material; a cold-rolling step of cold-rolling the hot-clad-rolled clad material; and one or more annealing steps of annealing the clad material during or after the cold-rolling step, or during and after the cold-rolling step, wherein a sheet thickness reduction ratio in a case in which the temperature of the clad material is in a temperature range of 500 to 400° C. is 90% or more in the hot clad rolling step.

In Embodiment 2 in the second disclosure, claim 9 is an aluminum alloy clad material for a heat exchanger, including: a core material of an aluminum alloy; a brazing filler material clad on one surface of the core material; and a sacrificial anode material clad on the other surface, wherein the core material includes an aluminum alloy including 0.02 to 0.40 mass % Si, 1.0 to 2.5 mass % Cu, 0.5 to 2.0 mass % Mn, and the balance of Al and inevitable impurities; the brazing filler material includes an aluminum alloy including 2.5 to 12.5 mass % Si, 0.05 to 1.20 mass % Fe, and the balance of Al and inevitable impurities; the sacrificial anode material includes an aluminum alloy of which the natural potential is lower than that of the core material after brazing-equivalent heating at 600° C. for 3 minutes; and the number density of an Al—Cu—Mn-based intermetallic compound having an equivalent circle diameter of 0.1 to 1.0 μm in the core material is 1.0×10⁶ particles/mm² or more.

In claim 10 in the present disclosure, the core material further includes one or more selected from 0.1 to 1.0 mass % Mg, 0.05 to 0.20 mass % Ti, 0.05 to 0.20 mass % V, 0.05 to 0.20 mass % Zr, and 0.05 to 0.20 mass % Cr, in claim 9.

In claim 11 in the present disclosure, the brazing filler material includes an aluminum alloy further including one or more selected from 0.5 to 8.0 mass % Zn, 0.05 to 2.50 mass % Cu, 0.05 to 2.00 mass % Mn, 0.05 to 0.20 mass % Ti, 0.05 to 0.20 mass % Zr, 0.05 to 0.20 mass % Cr, and 0.05 to 0.20 mass % V, in claim 9 or 10.

In claim 12 in the present disclosure, the brazing filler material includes an aluminum alloy further including one or two selected from 0.001 to 0.050 mass % Na and 0.001 to 0.050 mass % Sr, in any one of claims 9 to 11.

In the present disclosure, claim 13 is a method for producing the aluminum alloy clad material for a heat exchanger according to any one of claims 9 to 12, the method including: a casting step of casting each of the aluminum alloy for the core material, the aluminum alloy for the brazing filler material, and the aluminum alloy for the sacrificial anode material; a hot-rolling step of hot-rolling each of a cast brazing filler material ingot and a cast sacrificial anode material ingot to have a predetermined thickness; a cladding step of cladding the brazing filler material allowed to have the predetermined thickness by the hot rolling on one surface of a core material ingot and cladding the sacrificial anode material allowed to have the predetermined thickness by the hot rolling on the other surface of the core material ingot; a hot clad rolling step of hot-rolling the clad materials; a cold-rolling step of cold-rolling the hot-clad-rolled clad materials; and one or more annealing steps of annealing a cold-rolled sheet during or after the cold-rolling step, or during and after the cold-rolling step, wherein a sheet thickness reduction ratio in a case in which the temperatures of the clad materials are in a temperature range of 500 to 400° C. is 90% or more in the hot clad rolling step.

In Embodiment 3 in the second disclosure, an intermediate layer material is further clad between the core material and the brazing filler material clad on one surface or both surfaces of the core material, and the intermediate layer material includes an aluminum alloy including 0.5 to 8.0 mass % Zn, 0.05 to 1.50 mass % Si, 0.05 to 2.00 mass % Fe, and the balance of Al and inevitable impurities, in any one of claims 4 to 7 in Embodiment 1.

In Embodiment 4 in the second disclosure, an intermediate layer material is further clad between the core material and the brazing filler material clad on one surface of the core material, and the intermediate layer material includes an aluminum alloy including 0.5 to 8.0 mass % Zn, 0.05 to 1.50 mass % Si, 0.05 to 2.00 mass % Fe, and the balance of Al and inevitable impurities, in any one of claims 9 to 12 in Embodiment 2.

In claim 16 in the present disclosure, the intermediate layer material further includes one or more selected from 0.05 to 2.00 mass % Mn, 0.05 to 2.00 mass % Ni, 0.05 to 0.20 mass % Ti, 0.05 to 0.20 mass % Zr, 0.05 to 0.20 mass % Cr, and 0.05 to 0.20 mass % V, in claim 14 or 15.

In the present disclosure, claim 17 is a method for producing the aluminum alloy clad material for a heat exchanger according to claim 14 or 16, the method including: a casting step of casting each of the aluminum alloy for the core material, the aluminum alloy for the brazing filler material, and the aluminum alloy for the intermediate layer material; a hot-rolling step of hot-rolling each of a cast brazing filler material ingot and a cast intermediate layer material ingot to have a predetermined thickness; a cladding step of cladding the intermediate layer material allowed to have the predetermined thickness by the hot rolling on one surface or both surfaces of a core material ingot and cladding the brazing filler material allowed to have the predetermined thickness by the hot rolling on a surface, which is not closer to the core material, of the clad intermediate layer material; a hot clad rolling step of hot-rolling the clad materials; a cold-rolling step of cold-rolling the hot-clad-rolled clad materials; and one or more annealing steps of annealing the clad materials during or after the cold-rolling step, or during and after the cold-rolling step, wherein a sheet thickness reduction ratio in a case in which the temperatures of the clad materials are in a temperature range of 500 to 400° C. is 90% or more in the hot clad rolling step.

In the present disclosure, claim 18 is a method for producing the aluminum alloy clad material for a heat exchanger according to claim 15 or 16, the method including: a casting step of casting each of the aluminum alloy for the core material, the aluminum alloy for the brazing filler material, the aluminum alloy for the sacrificial anode material, and the aluminum alloy for the intermediate layer material; a hot-rolling step of hot-rolling each of a cast brazing filler material ingot, a cast sacrificial anode material ingot, and a cast intermediate layer material ingot to have a predetermined thickness; a cladding step of cladding the intermediate layer material allowed to have the predetermined thickness by the hot rolling on one surface of a core material ingot, cladding the brazing filler material allowed to have the predetermined thickness by the hot rolling on a surface, which is not closer to the core material, of the clad intermediate layer material, and cladding the sacrificial anode material allowed to have the predetermined thickness by the hot rolling on the other surface of the core material ingot; a hot clad rolling step of hot-rolling the clad materials; a cold-rolling step of cold-rolling the hot-clad-rolled clad materials; and one or more annealing steps of annealing the clad materials during or after the cold-rolling step, or during and after the cold-rolling step, wherein a sheet thickness reduction ratio in a case in which the temperatures of the clad materials are in a temperature range of 500 to 400° C. is 90% or more in the hot clad rolling step.

### Advantageous Effects of Invention

The aluminum alloy material for a heat exchanger and the aluminum alloy clad material for a heat exchanger according to the present disclosure is provided with high strength by precipitation strengthening and solid solution strengthening after brazing heating due to the definition of the state of the presence of an Al—Cu—Mn-based intermetallic compound.

### BRIEF DESCRIPTION OF DRAWING

FIG. 1 is an exploded perspective view illustrating a part of a conventional heat exchanger.

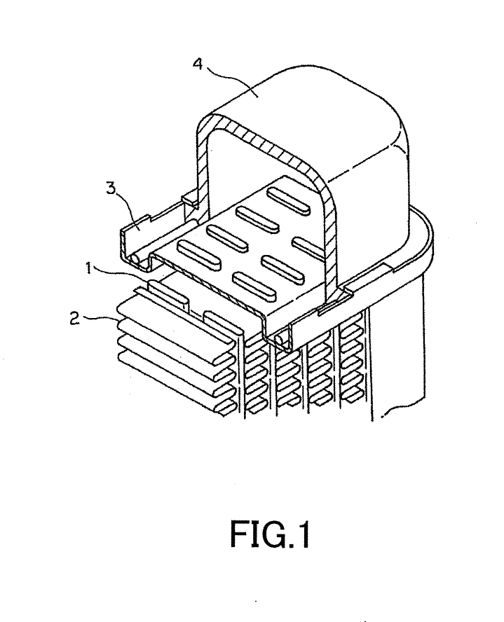

### DESCRIPTION OF EMBODIMENTS

An aluminum material and an aluminum clad material having high strength according to the present disclosure will be specifically described below. Hereinafter, “mass % (% by mass)” in an alloy composition is simply referred to as “%”.

1. Constitution of Present Disclosure

When being used as, for example, a fin and combined with a tube or the like containing a brazing filler material, the first disclosure of the present disclosure may be an aluminum alloy material of a bare material including only a core material. When being used as, for example, a tube and combined with a single-layered bare fin or when being used as a fin and combined with a tube containing no brazing filler material, Embodiment 1 in the second disclosure may be an aluminum alloy clad material having two layers or three layers obtained by using the aluminum alloy material according to the first disclosure as a core material and cladding a brazing filler material on one surface or both surfaces of the core material. Further, when being used as, for example, a tube in a radiator or the like, through which corrosive cooling water is allowed to flow on the inner surface of the tube, Embodiment 2 in the second disclosure may be an aluminum alloy clad material having three layers obtained by using the aluminum alloy material according to the first disclosure as a core material, cladding a brazing filler material on one surface of the core material, and cladding a sacrificial anode material on the other surface. Embodiment 3 in the second disclosure may be an aluminum alloy clad material having three layers or five layers obtained by arranging an intermediate layer between the core material and the brazing filler material on one surface or both surfaces of the core material in Embodiment 1. Further, Embodiment 4 in the second disclosure may be an aluminum alloy clad material having four layers obtained by arranging an intermediate layer between the core material and the brazing filler material on one surface of the core material in Embodiment 2.

2. Alloy Composition and Metal Structure

In a conventional aluminum alloy material for a heat exchanger, the material has been strengthened by highly densely precipitating an Al—Si—Mn-based fine intermetallic compound. In the technical idea of the present disclosure, it is necessary to further add Si in order to achieve higher strength; however, a large content of Si results in a great decrease in the melting point of the aluminum alloy material. Therefore, it is undesirable to increase the content of Si to not less than the content of Si in present circumstances in an aluminum alloy material for a heat exchanger requiring brazing heating.

In contrast, the present inventors found that a material having higher strength can be obtained by decreasing the content of Si in an aluminum alloy material and increasing the content of Cu in the aluminum alloy material, thereby highly densely precipitating an Al—Cu—Mn-based intermetallic compound. Like Si, Cu also has the action of decreasing the melting point of an aluminum alloy material. However, the influence of the action of Cu is not as great as that of Si. Therefore, the aluminum alloy material with a decreased Si content and an increased Cu content was developed.

It is desirable to decrease the content of Si in order to highly densely precipitating the Al—Cu—Mn-based intermetallic compound. This is because in the case of the large content of Si, an Al—Si—Mn-based intermetallic compound is precipitated, and the amount of precipitated Al—Cu—Mn-based intermetallic compound is reduced. The interfacial energy between the Al—Si—Mn-based intermetallic compound and a matrix is greater than the interfacial energy between the Al—Cu—Mn-based intermetallic compound and the matrix. As a result, the precipitation of the Al—Si—Mn-based intermetallic compound may result in a decrease in compound density. Therefore, it is necessary to regulate the content of Si to a low level.

In addition, the Al—Cu—Mn-based intermetallic compound is dynamically precipitated primarily during hot rolling. Therefore, it was found that it is necessary to define a working ratio at 500 to 400° C. in the hot rolling in order to highly densely precipitate the Al—Cu—Mn-based intermetallic compound.

3. Alloy Compositions

The alloy compositions of the aluminum alloy material and the core material, brazing filler material, sacrificial anode material, and intermediate layer material of an aluminum alloy clad material will be described below.

3-1. Aluminum Alloy Material, and Core Material of Aluminum Alloy Clad Material

The aluminum alloy material according to the present disclosure and the core material of the aluminum alloy clad material according to the present disclosure include an aluminum alloy containing 0.02 to 0.40% of Si, 1.0 to 2.5% of Cu, and 0.5 to 2.0% of Mn as essential elements, as well as the balance of Al and inevitable impurities. The aluminum alloy material may further contain, as selective additional elements, one or more selected from 0.1 to 1.0% of Mg, 0.05 to 0.20% of Ti, 0.05 to 0.20% of V, 0.05 to 0.20% of Zr, and 0.05 to 0.20% of Cr. The aluminum alloy material and the core material of the aluminum alloy clad material may also contain inevitable impurities such as Ca, Ni, and Sn, as well as the essential elements and the selective additional elements, so that the amount of each of the inevitable impurities is 0.05% or less, and the total amount of the inevitable impurities is 0.15% or less.

Si reacts with Mn to form an Al—Si—Mn-based intermetallic compound and to improve the strength of the material by dispersion strengthening or is solid-dissolved in an aluminum matrix to improve strength by solid solution strengthening. However, the Al—Si—Mn-based intermetallic compound is relatively coarse and results in a decrease in the precipitation density of a relatively fine Al—Cu—Mn-based intermetallic compound. Therefore, the content of Si is set to 0.40% or less. In contrast, a Si content of less than 0.02% requires use of a high-purity aluminum base metal, thereby resulting in an increase in cost. Accordingly, the content of Si is set to 0.02 to 0.40%. The preferred content of Si is 0.02 to 0.30%.

Cu reacts with Mn to form an Al—Cu—Mn-based intermetallic compound. In addition, Cu reacts with Al to form Al₂Cu. Al₂Cu is aging-precipitated after brazing, thereby improving the strength of the material. A Cu content of less than 1.0% results in the insufficient obtainment of the effect described above. In contrast, a Cu content of more than 2.5% may result in a decrease in the melting point of the aluminum alloy material. In addition, Al₂Cu becomes prone to be precipitated in a grain boundary, the potential between the vicinity of the grain boundary and a matrix is lowered, and intergranular corrosion therefore becomes prone to occur. Accordingly, the content of Cu is set to 1.0 to 2.5%. The preferred content of Cu is 1.5 to 2.5%.

Mn reacts with Si and Cu to form Al—Si—Mn-based and Al—Cu—Mn-based intermetallic compounds. The intermetallic compounds are crystallized or precipitated to improve the strength of the material by dispersion strengthening. A Mn content of less than 0.5% results in the insufficient obtainment of the effect described above. In contrast, a Mn content of more than 2.0% is prone to result in the formation of a giant intermetallic compound in casting, thereby deteriorating formability. Accordingly, the content of Mn is set to 0.5 to 2.0%. The preferred content of Mn is 1.0 to 2.0%.

Mg may be contained because of forming, together with Cu, Al₂CuMg, to improve the strength of the material. A Mg content of less than 0.1% prevents the effect described above from being obtained. In contrast, a Mg content of more than 1.0% precludes brazing. Accordingly, the content of Mg is set to 0.1 to 1.0%. The preferred content of Mg is 0.1 to 0.8%.

Ti may be contained because of improving the strength of the material by solid solution strengthening. A Ti content of less than 0.05% prevents the effect described above from being obtained. In contrast, a Ti content of more than 0.20% is prone to result in the formation of a giant intermetallic compound in casting, thereby deteriorating formability. Accordingly, the content of Ti is set to 0.05 to 0.20%. The preferred content of Ti is 0.05 to 0.15%.

Cr may be contained because of improving the strength of the material by solid solution strengthening. A Cr content of less than 0.05% prevents the effect described above from being obtained. In contrast, a Cr content of more than 0.20% is prone to result in the formation of a giant intermetallic compound in casting, thereby deteriorating formability. Accordingly, the content of Cr is set to 0.05 to 0.20%. The preferred content of Cr is 0.05 to 0.15%.

Zr may be contained because of improving the strength of the material by solid solution strengthening. A Zr content of less than 0.05% prevents the effect described above from being obtained. In contrast, a Zr content of more than 0.20% is prone to result in the formation of a giant intermetallic compound in casting, thereby deteriorating formability. Accordingly, the content of Zr is set to 0.05 to 0.20%. The preferred content of Zr is 0.05 to 0.15%.

V may be contained because of improving the strength of the material by solid solution strengthening. A V content of less than 0.05% prevents the effect described above from being obtained. In contrast, a V content of more than 0.20% is prone to result in the formation of a giant intermetallic compound in casting, thereby deteriorating formability. Accordingly, the content of V is set to 0.05 to 0.20%. The preferred content of V is 0.05 to 0.15%.

At least one of these Mg, Ti, Zr, Cr, and V may be added to the aluminum alloy material and the core material of the aluminum alloy clad material, as needed.

3-2. Brazing Filler Material of Aluminum Alloy Clad Material

The brazing filler material of the aluminum alloy clad material according to the present disclosure includes an aluminum alloy including 2.5 to 12.5% of Si and 0.05 to 1.20% of Fe as essential elements, as well as the balance of Al and inevitable impurities.

The brazing filler material may further contain, as first selective additional elements, one or more selected from 0.5 to 8.0% of Zn, 0.05 to 2.50% of Cu, 0.05 to 2.00% of Mn, 0.05 to 0.20% of Ti, 0.05 to 0.20% of Zr, 0.05 to 0.20% of Cr, and 0.05 to 0.20% of V. The brazing filler material may further contain, as second selective additional elements, one or two selected from 0.001 to 0.050% of Na and 0.001 to 0.050% of Sr. The brazing filler material of the aluminum alloy clad material may also contain inevitable impurities such as Ca, Ni, and Sn, as well as the essential elements and selective additional elements described above, so that the amount of each of the inevitable impurities is 0.05% or less, and the total amount of the inevitable impurities is 0.15% or less.

The addition of Si results in a decrease in the melting point of the brazing filler material to generate a liquid phase, thereby enabling brazing. A Si content of less than 2.5% results in the generation of a slight amount of liquid phase, whereby poor brazing becomes prone to occur. In contrast, when the content of Si is more than 12.5%, use of the brazing filler material in a tube material results in the excessive amount of Si diffused in an opposite material such as a fin, thereby causing the opposite material to be melted. Accordingly, the content of Si is set to 2.5 to 12.5%. The preferred content of Si is 4.0 to 12.0%.

Fe is prone to result in the formation of Al—Fe-based and Al—Fe—Si-based intermetallic compounds, and therefore results in a decrease in the amount of Si effective for brazing, thereby deteriorating brazability. An Fe content of less than 0.05% requires use of a high-purity aluminum base metal, thereby resulting in an increase in cost. In contrast, an Fe content of more than 1.20% results in a decrease in the amount of Si effective for brazing, thereby resulting in insufficient brazing. Accordingly, the content of Fe is set to 0.05 to 1.20%. The preferred content of Fe is 0.05 to 1.00%.

Zn may be contained because of enabling a lower pitting potential and allowing the formation of a potential difference between Zn and a core material, thereby enabling corrosion resistance to be improved by a sacrificial protection effect. A Zn content of less than 0.5% prevents the effect of improving corrosion resistance by the sacrificial protection effect from being sufficiently obtained. In contrast, a Zn content of more than 8.0% results in a higher corrosion rate, thereby causing a sacrificial protection layer to early disappear and deteriorating corrosion resistance. Accordingly, the content of Zn is set to 0.5 to 8.0%. The preferred content of Zn is 0.5 to 7.0%.

Cu may be contained because of improving the strength of the brazing filler material by solid solution strengthening. A Cu content of less than 0.05% causes the effect described above to be insufficient. In contrast, a Cu content of more than 2.50% results in an increase in the possibility of cracking of an aluminum alloy in casting. Accordingly, the content of Cu is set to 0.05 to 2.50%. The preferred content of Cu is 0.20 to 2.50%.

Mn may be contained because of improving the strength and corrosion resistance of the brazing filler material. A Mn content of less than 0.05% prevents the effect described above from being sufficiently obtained. In contrast, a Mn content of more than 2.00% is prone to result in the formation of a giant intermetallic compound in casting, thereby deteriorating workability. Accordingly, the content of Mn is set to 0.05 to 2.00%. The preferred content of Mn is 0.05 to 1.50%.

Ti may be contained because of improving the strength of the brazing filler material by solid solution strengthening. A Ti content of less than 0.05% prevents the effect described above from being obtained. In contrast, a Ti content of more than 0.20% is prone to result in the formation of a giant intermetallic compound in casting, thereby deteriorating formability. Accordingly, the content of Ti is set to 0.05 to 0.20%. The preferred content of Ti is 0.05 to 0.15%.

Cr may be contained because of improving the strength of the brazing filler material by solid solution strengthening. A Cr content of less than 0.05% prevents the effect described above from being obtained. In contrast, a Cr content of more than 0.20% is prone to result in the formation of a giant intermetallic compound in casting, thereby deteriorating formability. Accordingly, the content of Cr is set to 0.05 to 0.20%. The preferred content of Cr is 0.05 to 0.15%.

Zr may be contained because of improving the strength of the brazing filler material by solid solution strengthening. A Zr content of less than 0.05% prevents the effect described above from being obtained. In contrast, a Zr content of more than 0.20% is prone to result in the formation of a giant intermetallic compound in casting, thereby deteriorating formability. Accordingly, the content of Zr is set to 0.05 to 0.20%. The preferred content of Zr is 0.05 to 0.15%.

V may be contained because of improving the strength of the brazing filler material by solid solution strengthening. A V content of less than 0.05% prevents the effect described above from being obtained. In contrast, a V content of more than 0.20% is prone to result in the formation of a giant intermetallic compound in casting, thereby deteriorating formability. Accordingly, the content of V is set to 0.05 to 0.20%. The preferred content of V is 0.05 to 0.15%.

Na and Sr exhibit the effect of fragmenting Si particles in the brazing filler material. When the content of each of Na and Sr is less than 0.001%, the effect described above is not sufficiently obtained. In contrast, when the content of each of Na and Sr is more than 0.050%, an oxide film on a surface of the brazing filler material becomes thick, thereby deteriorating brazability. Accordingly, the content of both Na and Sr is set to 0.001 to 0.050%. The preferred content of each of Na and Sr is 0.005 to 0.050%.

3-3. Sacrificial Anode Material of Aluminum Alloy Clad Material

The sacrificial anode material of the aluminum alloy clad material according to the present disclosure includes an aluminum alloy of which the natural potential is lower than that of the core material after brazing-equivalent heating at 600° C. for 3 minutes. In the present disclosure, the high content of Cu in the core material allows the natural potential of the core material to be high, and therefore, a 1000-series alloy, a 3000-series alloy, a 5000-series alloy, a 6000-series alloy, and a 7000-series alloy exhibit action as the sacrificial anode material. The natural potential was allowed to be a potential measured 24 hours after the start of the measurement of the natural potential with immersion in a solution obtained by adding 1 mL/L of acetic acid to 5% NaCl. A silver/silver chloride electrode was used as a reference electrode.

3-4. Intermediate Layer Material of Aluminum Alloy Clad Material

The intermediate layer material of the aluminum alloy clad material according to the present disclosure is arranged between the core material and the brazing filler material. The intermediate layer material has the action of forming the diffusion region of Zn by brazing, expressing a sacrificial protection function, and improving corrosion resistance. The intermediate layer material of the aluminum alloy material according to the present disclosure includes an aluminum alloy containing 0.5 to 8.0% of Zn, 0.05 to 1.50% of Si, and 0.05 to 2.00% of Fe as essential elements, as well as the balance of Al and inevitable impurities. The intermediate layer material may further contain, as selective additional elements, one or more selected from 0.05 to 2.00% of Mn, 0.05 to 2.00% of Ni, 0.05 to 0.20% of Ti, 0.05 to 0.20% of Zr, 0.05 to 0.20% of Cr, and 0.05 to 0.20% of V. The intermediate layer material of the aluminum alloy clad material may also contain inevitable impurities such as Ca and Sn, as well as the essential elements and selective additional elements described above, so that the amount of each of the inevitable impurities is 0.05% or less, and the total amount of the inevitable impurities is 0.15% or less.

Zn enables a lower pitting potential and allows the formation of a potential difference between Zn and the core material, thereby enabling corrosion resistance to be improved by a sacrificial protection effect. A Zn content of less than 0.5% prevents the effect of improving corrosion resistance by the sacrificial protection effect from being sufficiently obtained. In contrast, a Zn content of more than 8.0% results in a higher corrosion rate, thereby causing a sacrificial protection layer to early disappear and deteriorating corrosion resistance. Accordingly, the content of Zn is set to 0.5 to 8.0%. The preferred content of Zn is 0.5 to 7.0%.

Si forms, together with Fe, an Al—Fe—Si-based intermetallic compound or forms, together with Fe and Mn in a case in which Mn is simultaneously contained, an Al—Fe—Mn—Si-based intermetallic compound, allows the strength of the intermediate layer material to be improved by dispersion strengthening, or is solid-dissolved in an aluminum matrix to improve the strength of the intermediate layer material by solid solution strengthening. However, Si causes the potential of the sacrificial protection layer to be higher, and therefore inhibits the sacrificial protection effect, thereby deteriorating corrosion resistance. A Si content of less than 0.05% requires use of a high-purity aluminum base metal, thereby resulting in an increase in cost. In contrast, a Si content of more than 1.50% causes the pitting potential of the intermediate layer material to be higher, thereby resulting in lost sacrificial protection effect and deteriorating corrosion resistance. Accordingly, the content of Si is set to 0.05 to 1.50%. The preferred content of Si is 0.05 to 1.40%.

Fe forms, together with Si, an Al—Fe—Si-based intermetallic compound or forms, together with Si and Mn in a case in which Mn is simultaneously contained, an Al—Fe—Mn—Si-based intermetallic compound, and improves the strength of the intermediate layer material by dispersion strengthening. An Fe content of less than 0.05% requires use of a high-purity aluminum base metal, thereby resulting in an increase in cost. In contrast, an Fe content of more than 2.00% is prone to result in the formation of a giant intermetallic compound in casting, thereby deteriorating formability. Accordingly, the content of Fe is set to 0.05 to 2.00%. The preferred content of Fe is 0.05 to 1.50%.

Mn may be contained because of improving the strength and corrosion resistance of the intermediate layer material. A Mn content of less than 0.05% prevents the effect described above from being sufficiently obtained. In contrast, a Mn content of more than 2.00% is prone to result in the formation of a giant intermetallic compound in casting, thereby deteriorating formability. Accordingly, the content of Mn is set to 0.05 to 2.00%. The preferred content of Mn is 0.05 to 1.50%.

Ni forms an Al—Ni-based intermetallic compound or forms, together with Fe, an Al—Fe—Ni-based intermetallic compound. Each of these intermetallic compounds has a much higher corrosion potential than the corrosion potential of the matrix of aluminum and therefore acts as a corrosion cathode site. Therefore, when these intermetallic compounds are dispersed in the intermediate layer material, the origin of corrosion is dispersed. As a result, corrosion is inhibited from proceeding in a depth direction, corrosion resistance is improved, and Ni may be therefore contained. A Ni content of less than 0.05% prevents the effect described above from being sufficiently obtained. In contrast, a Ni content of more than 2.00% is prone to result in the formation of a giant intermetallic compound in casting, thereby deteriorating formability. Accordingly, the content of Ni is set to 0.05 to 2.00%. The preferred content of Ni is 0.05 to 1.80%.

Ti may be contained because of improving the strength of the intermediate layer material by solid solution strengthening. A Ti content of less than 0.05% prevents the effect described above from being obtained. In contrast, a Ti content of more than 0.20% is prone to result in the formation of a giant intermetallic compound in casting, thereby deteriorating formability. Accordingly, the content of Ti is set to 0.05 to 0.20%. The preferred content of Ti is 0.05 to 0.15%.

Cr may be contained because of improving the strength of the intermediate layer material by solid solution strengthening. A Cr content of less than 0.05% prevents the effect described above from being obtained. In contrast, a Cr content of more than 0.20% is prone to result in the formation of a giant intermetallic compound in casting, thereby deteriorating formability. Accordingly, the content of Cr is set to 0.05 to 0.20%. The preferred content of Cr is 0.05 to 0.15%.

Zr may be contained because of improving the strength of the intermediate layer material by solid solution strengthening. A Zr content of less than 0.05% prevents the effect described above from being obtained. In contrast, a Zr content of more than 0.20% is prone to result in the formation of a giant intermetallic compound in casting, thereby deteriorating formability. Accordingly, the content of Zr is set to 0.05 to 0.20%. The preferred content of Zr is 0.05 to 0.15%.

V may be contained because of improving the strength of the intermediate layer material by solid solution strengthening. A V content of less than 0.05% prevents the effect described above from being obtained. In contrast, a V content of more than 0.20% is prone to result in the formation of a giant intermetallic compound in casting, thereby deteriorating formability. Accordingly, the content of V is set to 0.05 to 0.20%. The preferred content of V is 0.05 to 0.15%.

4. Metal Structure

In the aluminum alloy material and the aluminum alloy clad material according to the present disclosure, the number density of an Al—Cu—Mn-based intermetallic compound having an equivalent circle diameter (diameter of equivalent circle) of 0.1 to 1.0 μm is 1.0×10⁶/mm² or more. The reason for limiting the range of the equivalent circle diameter of the intermetallic compound to 0.1 to 1.0 μm will be described below.

The fine dispersion of an intermetallic compound in an aluminum alloy material is known to result in improvement in strength due to dispersion strengthening. In addition, a certain amount of the intermetallic compound is solid-dissolved in a base metal by a heat input at the time of brazing heating. A case in which the intermetallic compound is fine is found to also result in an increase in the increment of the amount of solid solution at the time of brazing, thereby further improving an increase in strength due to solid solution strengthening. An equivalent circle diameter of the Al—Cu—Mn-based intermetallic compound of less than 0.1 μm causes the almost overall intermetallic compound to be solid-dissolved in brazing heating and therefore results in the ineffective contribution of the dispersion strengthening after the brazing heating. In contrast, an equivalent circle diameter of the Al—Cu—Mn-based intermetallic compound of more than 1.0 μm causes a decrease in the increment of the amount of solid solution in brazing heating and also results in the ineffective contribution of the solid solution strengthening. Accordingly, the range of the equivalent circle diameter of the Al—Cu—Mn-based intermetallic compound is limited to 0.1 to 1.0 μm. The preferred range of the equivalent circle diameter is 0.2 to 1.0 μm.

The number density will now be described. The reason why the number density of the Al—Cu—Mn-based intermetallic compound having an equivalent circle diameter of 0.1 to 1.0 μm is set to 1.0×10⁶/mm² or more is because when the number density is less than 1.0×10⁶/mm², it is impossible to obtain the sufficient increment of the amount of solid solution in brazing heating, and it is impossible to allow the effective contribution of solid solution strengthening. The number density is preferably 2.0×10⁶/mm² or more. The upper limit value of the number density is 2.0×10⁷/mm² in the present disclosure although depending on the composition of an aluminum alloy used and on a production method.

5. Method for Producing Aluminum Alloy Material

5-1. Each Production Step

A method for producing the aluminum alloy material of the first disclosure according to the present disclosure includes: a casting step of casting an aluminum alloy; a hot-rolling step of hot-rolling a cast ingot; a cold-rolling step of cold-rolling a hot-rolled sheet; and one or more annealing steps of annealing the cold-rolled sheet during or after the cold-rolling step, or during and after the cold-rolling step. A homogenization treatment step of performing the homogenization treatment of the cast ingot can be added.

A method for producing the aluminum alloy clad material of the second disclosure according to the present disclosure includes: a casting step of casting each of an aluminum alloy for a core material and an aluminum alloy for each of needed skin materials (a brazing filler material, a sacrificial anode material, and an intermediate layer material); a hot-rolling step of hot-rolling each cast ingot of each skin material to have a predetermined thickness; a cladding step of cladding a core material and the skin materials allowed to have the predetermined thicknesses by the hot rolling; a hot clad rolling step of hot-rolling the clad materials; a cold-rolling step of cold-rolling the hot-clad-rolled clad materials; and one or more annealing steps of annealing the clad materials during or after the cold-rolling step, or during and after the cold-rolling step. In Embodiment 2, a homogenization treatment step of performing the homogenization treatment of the cast ingot for the core material can be added.

The second disclosure includes: Embodiment 1 in which the aluminum alloy material according to the first disclosure is used as a core material, and a brazing filler material is clad on one surface or both surfaces of the core material; Embodiment 2 in which the aluminum alloy material according to the first disclosure is used as a core material, a brazing filler material is clad on one surface of the core material, and a sacrificial anode material is clad on the other surface; Embodiment 3 in which an intermediate layer is arranged between the core material and the brazing filler material on one surface or both surfaces of the core material in Embodiment 1; and Embodiment 4 in which an intermediate layer is arranged between the core material and the brazing filler material on the one surface of the core material in Embodiment 2.

Excellent strength after brazing heating is achieved by controlling each of a metal structure before brazing in the aluminum alloy material according to the first disclosure and the metal structure of the core material before brazing in the aluminum alloy clad material according to the second disclosure. As a result of intensive study, the present inventors found that a production step that exerts the greatest influence on the control of a metal structure is a hot-rolling step. A control method in this step will be described in detail below. Commonly performed conditions can be adopted in each step except the hot-rolling step.

5-2. Hot-Rolling Step

The methods for producing the aluminum alloy material and the aluminum alloy clad material according to the present disclosure have features in the hot-rolling steps. In such a hot-rolling step, a sheet thickness reduction ratio (rolling reduction ratio) in a case in which the hot-rolled sheet is in a temperature range of 500 to 400° C. is set to 90% or more. The reason thereof will be described below.

The Al—Cu—Mn-based intermetallic compound is generated in the hot rolling, and a nucleation site in such a case is working strain applied to the hot-rolled sheet in the hot rolling. In the Al—Cu—Mn-based intermetallic compound, nucleation is induced in a temperature range of 400 to 500° C., preferably 400 to 490° C. Therefore, working is performed at a rolling reduction ratio of 90% or more in a temperature range of 500 to 400° C. in the hot rolling, whereby the nucleation of the Al—Cu—Mn-based intermetallic compound proceeds in a state in which there are great many nucleation sites, and a fine, high-density Al—Cu—Mn-based intermetallic compound of interest is obtained. A rolling reduction ratio of less than 90% in a temperature range of 500 to 400° C. in the hot rolling results in insufficient nucleation sites in the Al—Cu—Mn-based intermetallic compound, whereby it is impossible to allow the number density of the Al—Cu—Mn-based intermetallic compound having an equivalent circle diameter of 0.1 to 1.0 μm to be 1.0×10⁶/mm² or more. The rolling reduction ratio described above is preferably 92% or more. The upper limit value of the rolling reduction ratio depends on an alloy composition and a rolling apparatus, and is set to 99% in the present disclosure.

5-3. Other Steps

Usual conditions can be adopted in the steps other than the hot-rolling step, as described above. A semi-continuous casting method or a continuous casting method is adopted in the casting step. A heat treatment condition of 5 to 15 hours at 400 to 600° C. is preferred in the homogenization treatment step. A final rolling reduction ratio is preferably set to 10 to 98% in the cold-rolling step. In the annealing step, it is preferable to set a temperature-raising rate until reaching a retention temperature to 20 to 60° C./h, a retention temperature to 250 to 450° C. in a retention stage, and a retention time to 1 to 8 hours. The single-sided cladding ratios of the brazing filler material, the sacrificial anode material, and the intermediate layer material which are the skin materials are preferably set to 3 to 25% in the aluminum alloy clad material according to the present disclosure.

### EXAMPLES

The present disclosure will now be described in more detail with reference to Present Disclosure Examples and Comparative Examples. However, the present disclosure is not limited thereto.

Each of core material alloys having alloy compositions set forth in Table 1, brazing filler material alloys having alloy compositions set forth in Table 2, sacrificial anode material alloys having alloy compositions set forth in Table 3, and intermediate layer material alloys having alloy compositions set forth in Table 4 was cast by DC casting. In the core material alloys, the alloys other than the A2 alloy were subjected to homogenization treatment for 5 hours at 560° C., and the homogenization treatment of the A2 alloy was omitted. Then, both surfaces of each ingot were faced and finished. The thickness of each of the faced ingots was set to 400 mm. The final sheet thicknesses of a brazing filler material, a sacrificial anode material, and an intermediate layer material were calculated so as to achieve a cladding ratio of 10%, and the materials were subjected to heating at 480° C. for 3 hours and then subjected to a hot-rolling step so as to achieve the thickness of the joined materials needed for the cladding ratio. In Tables 1 to 4, “-” denotes less than a detection limit.

TABLE 1

| | | Alloy composition (mass %) | | | | | | | | |
|---|---|---|---|---|---|---|---|---|---|---|
| | | | | | | | | | | Al and |
| | Alloy | | | | | | | | | inevitable |
| | designation | Si | Cu | Mn | Mg | Ti | V | Zr | Cr | impurities |
| Present | A1 | 0.20 | 1.8 | 1.2 | — | — | — | — | — | Balance |
| Disclosure | A2 | 0.02 | 1.8 | 1.2 | — | — | — | — | — | Balance |
| Examples | A3 | 0.40 | 1.8 | 1.2 | — | — | — | — | — | Balance |
| | A4 | 0.20 | 1.0 | 1.2 | — | — | — | — | — | Balance |
| | A5 | 0.20 | 2.5 | 1.2 | — | — | — | — | — | Balance |
| | A6 | 0.20 | 1.8 | 0.5 | — | — | — | — | — | Balance |
| | A7 | 0.20 | 1.8 | 2.0 | — | — | — | — | — | Balance |
| | A8 | 0.20 | 1.8 | 1.2 | — | 0.20 | — | — | — | Balance |
| | A9 | 0.20 | 1.8 | 1.2 | — | — | 0.20 | — | — | Balance |
| | A10 | 0.20 | 1.8 | 1.2 | — | — | — | 0.20 | — | Balance |
| | A11 | 0.20 | 1.8 | 1.2 | — | — | — | — | 0.20 | Balance |
| | A12 | 0.20 | 1.8 | 1.2 | — | 0.20 | 0.20 | 0.20 | 0.20 | Balance |
| | A13 | 0.20 | 1.8 | 1.2 | 0.4 | — | — | — | — | Balance |
| | A14 | 0.02 | 1.8 | 1.2 | 0.4 | — | — | — | — | Balance |
| | A15 | 0.40 | 1.8 | 1.2 | 0.4 | — | — | — | — | Balance |
| | A16 | 0.20 | 1.0 | 1.2 | 0.1 | — | — | — | — | Balance |
| | A17 | 0.20 | 2.5 | 1.2 | 0.1 | — | — | — | — | Balance |
| | A18 | 0.20 | 1.8 | 0.5 | 0.1 | — | — | — | — | Balance |
| | A19 | 0.20 | 1.8 | 2.0 | 0.1 | — | — | — | — | Balance |
| | A20 | 0.20 | 1.8 | 1.2 | 1.0 | 0.20 | — | — | — | Balance |
| | A21 | 0.20 | 1.8 | 1.2 | 1.0 | — | 0.20 | — | — | Balance |
| | A22 | 0.20 | 1.8 | 1.2 | 1.0 | — | — | 0.20 | — | Balance |
| | A23 | 0.20 | 1.8 | 1.2 | 1.0 | — | — | — | 0.20 | Balance |
| | A24 | 0.20 | 1.8 | 1.2 | 1.0 | 0.20 | 0.20 | 0.20 | 0.20 | Balance |
| Comparative | A25 | 0.50 | 1.8 | 1.2 | — | — | — | — | — | Balance |
| Examples | A26 | 0.20 | 0.9 | 1.2 | — | — | — | — | — | Balance |
| | A27 | 0.20 | 2.6 | 1.2 | — | — | — | — | — | Balance |
| | A28 | 0.20 | 1.8 | 0.4 | — | — | — | — | — | Balance |
| | A29 | 0.20 | 1.8 | 1.2 | — | 0.25 | 0.25 | 0.25 | 0.25 | Balance |
| | A30 | 0.20 | 1.8 | 1.2 | — | 0.25 | — | — | — | Balance |
| | A31 | 0.20 | 1.8 | 1.2 | — | — | 0.25 | — | — | Balance |
| | A32 | 0.20 | 1.8 | 1.2 | — | — | — | 0.25 | — | Balance |
| | A33 | 0.20 | 1.8 | 1.2 | — | — | — | — | 0.25 | Balance |
| | A34 | 0.20 | 1.8 | 2.1 | — | — | — | — | — | Balance |
| | A35 | 0.50 | 1.8 | 1.2 | 0.4 | — | — | — | — | Balance |
| | A36 | 0.20 | 0.9 | 1.2 | 0.4 | — | — | — | — | Balance |
| | A37 | 0.20 | 2.6 | 1.2 | 0.4 | — | — | — | — | Balance |
| | A38 | 0.20 | 1.8 | 0.4 | 0.1 | — | — | — | — | Balance |
| | A39 | 0.20 | 1.8 | 1.2 | 0.1 | 0.25 | 0.25 | 0.25 | 0.25 | Balance |
| | A40 | 0.20 | 1.8 | 1.2 | 1.0 | 0.25 | — | — | — | Balance |
| | A41 | 0.20 | 1.8 | 1.2 | 1.0 | — | 0.25 | — | — | Balance |
| | A42 | 0.20 | 1.8 | 1.2 | 1.0 | — | — | 0.25 | — | Balance |
| | A43 | 0.20 | 1.8 | 1.2 | 1.0 | — | — | — | 0.25 | Balance |
| | A44 | 0.20 | 1.8 | 2.1 | 1.0 | — | — | — | — | Balance |
| | A45 | 0.20 | 1.8 | 1.2 | 0.09 | — | — | — | — | Balance |
| | A46 | 0.20 | 1.8 | 1.2 | 1.1 | — | — | — | — | Balance |

TABLE 2

| | | Alloy composition (mass %) | | | | | | | | | | | |
|---|---|---|---|---|---|---|---|---|---|---|---|---|---|
| | | | | | | | | | | | | | Al and |
| | Alloy | | | | | | | | | | | | inevitable |
| | designation | Si | Fe | Cu | Mn | Zn | Ti | V | Zr | Cr | Na | Sr | impurities |
| Present | B1 | 10.0 | 0.20 | — | — | — | — | — | — | — | — | — | Balance |
| Disclosure | B2 | 2.5 | 0.20 | — | — | — | 0.05 | — | — | — | 0.001 | — | Balance |
| Examples | B3 | 12.5 | 0.20 | — | — | — | — | 0.05 | — | — | — | 0.001 | Balance |
| | B4 | 10.0 | 0.05 | — | — | — | — | — | 0.05 | — | 0.050 | — | Balance |
| | B5 | 10.0 | 1.20 | — | — | — | — | — | — | 0.05 | — | 0.050 | Balance |
| | B6 | 10.0 | 0.20 | 0.05 | — | — | 0.20 | 0.20 | 0.20 | 0.20 | — | — | Balance |
| | B7 | 10.0 | 0.20 | 2.50 | — | — | — | — | — | — | — | — | Balance |
| | B8 | 10.0 | 0.20 | — | 0.05 | — | — | — | — | — | — | — | Balance |
| | B9 | 10.0 | 0.20 | — | 2.00 | — | — | — | — | — | — | — | Balance |
| | B10 | 10.0 | 0.20 | — | — | 0.5 | — | — | — | — | — | — | Balance |
| | B11 | 10.0 | 0.20 | — | — | 8.0 | — | — | — | — | — | — | Balance |
| Comparative | B12 | 2.0 | 0.20 | — | — | — | — | — | — | — | — | — | Balance |
| Examples | B13 | 13.0 | 0.20 | — | — | — | — | — | — | — | — | — | Balance |
| | B14 | 10.0 | 1.30 | — | — | — | — | — | — | — | — | — | Balance |
| | B15 | 10.0 | 0.20 | 2.60 | — | — | — | — | — | — | — | — | Balance |
| | B16 | 10.0 | 0.20 | — | 2.20 | — | — | — | — | — | — | — | Balance |
| | B17 | 10.0 | 0.20 | — | — | — | 0.30 | 0.30 | 0.30 | 0.30 | — | — | Balance |
| | B18 | 10.0 | 0.20 | — | — | — | — | — | — | — | 0.060 | — | Balance |
| | B19 | 10.0 | 0.20 | — | — | — | — | — | — | — | — | 0.060 | Balance |
| | B20 | 10.0 | 0.20 | — | — | — | — | — | — | — | 0.060 | 0.060 | Balance |
| | B21 | 10.0 | 0.20 | — | — | 8.5 | — | — | — | — | — | — | Balance |

TABLE 3

| | | Alloy composition (mass %) | | | | | |
|---|---|---|---|---|---|---|---|
| | | | | | | | Al and |
| | Alloy | | | | | | inevitable |
| | designation | Zn | Si | Mn | Mg | Cu | impurities |
| Present | C1 | — | — | — | — | — | Balance |
| Disclosure | C2 | 4.0 | — | — | — | — | Balance |
| Examples | C3 | 4.0 | 0.8 | — | — | — | Balance |
| | C4 | 4.0 | — | — | 1.50 | — | Balance |
| | C5 | 4.0 | 0.8 | 1.0 | — | — | Balance |
| | C6 | — | 0.3 | — | 0.55 | — | Balance |
| Comparative | C7 | — | — | — | — | 2.5 | Balance |
| Examples | C8 | — | — | 1.0 | — | 1.5 | Balance |

TABLE 4

| | | Alloy composition (mass %) | | | | | | | | | |
|---|---|---|---|---|---|---|---|---|---|---|---|
| | | | | | | | | | | | Al and |
| | Alloy | | | | | | | | | | inevitable |
| | designation | Zn | Si | Fe | Mn | Ni | Ti | V | Zr | Cr | impurities |
| Present | D1 | 4.0 | 0.20 | 0.20 | — | — | — | — | — | — | Balance |
| Disclosure | D2 | 0.5 | 0.05 | 0.05 | — | — | 0.05 | — | — | — | Balance |
| Examples | D3 | 8.0 | 0.20 | 0.20 | — | — | 0.20 | 0.20 | 0.20 | 0.20 | Balance |
| | D4 | 4.0 | 1.50 | 0.20 | — | — | — | 0.05 | — | — | Balance |
| | D5 | 4.0 | 0.20 | 2.00 | — | — | — | — | 0.05 | — | Balance |
| | D6 | 4.0 | 0.20 | 0.20 | 0.05 | — | — | — | — | 0.05 | Balance |
| | D7 | 4.0 | 0.20 | 0.20 | 2.00 | — | — | — | — | — | Balance |
| | D8 | 4.0 | 0.20 | 0.20 | — | 0.05 | — | — | — | — | Balance |
| | D9 | 4.0 | 0.20 | 0.20 | — | 2.00 | — | — | — | — | Balance |
| Comparative | D10 | 4.0 | 1.60 | 0.20 | — | — | — | — | — | — | Balance |
| Examples | D11 | 4.0 | 0.20 | 2.20 | — | — | — | — | — | — | Balance |
| | D12 | 4.0 | 0.20 | 0.20 | — | — | 0.30 | 0.30 | 0.30 | 0.30 | Balance |
| | D13 | 9.0 | 0.20 | 0.20 | — | — | — | — | — | — | Balance |
| | D14 | 4.0 | 0.20 | 0.20 | — | 2.20 | — | — | — | — | Balance |
| | D15 | 4.0 | 0.20 | 0.20 | 2.20 | — | — | — | — | — | Balance |

These alloys were used and subjected to a cladding step in any combination of: one-layer structure <the first disclosure> with only aluminum alloy material; two-layer structure <Embodiment 1 of the second disclosure> with skin material 1 (brazing filler material)/core material; three-layer structure <Embodiment 1 of the second disclosure> with skin material 1 (brazing filler material)/core material/skin material 2 (brazing filler material); three-layer structure <Embodiment 2 of the second disclosure> with skin material 1 (brazing filler material)/core material/skin material 2 (sacrificial anode material); four-layer structure <Embodiment 3 of the second disclosure> with skin material 1 (brazing filler material)/skin material 2 (intermediate layer material)/core material/skin material 3 (brazing filler material); four-layer structure <Embodiment 4 of the second disclosure> with skin material 1 (brazing filler material)/skin material 2 (intermediate layer material)/core material/skin material 3 (sacrificial anode material); and five-layer structure <Embodiment 3 of the second disclosure> with skin material 1 (brazing filler material)/skin material 2 (intermediate layer material)/core material/skin material 3 (intermediate layer material)/skin material 4 (brazing filler material). These were subjected to heating at 480° C. for 3 hours and then to a hot clad rolling step to have a thickness of 3 mm. Detailed conditions after the hot clad rolling are set forth in Table 5. A sample of an aluminum alloy material and an aluminum alloy clad material was produced as a rolled sheet having a final sheet thickness of 0.2 mm in any of: step combination 1: order of cold rolling step→final annealing; and step combination 2: order of cold rolling→intermediate annealing→final cold rolling→final annealing. A combination of layers in each sample is set forth in Tables 6 to 9.

TABLE 5

| | | | Rolling reduction in |
|---|---|---|---|
| | Alloy | Step | hot clad rolling |
| | designation | combination | at 400° C. |
| Present Disclosure | E1 | 1 | 90% |
| Examples | E2 | 1 | 95% |
| | E3 | 2 | 99% |
| Comparative Examples | E4 | 1 | 85% |

TABLE 6

| | | | | | | | | | Brazability | | |
|---|---|---|---|---|---|---|---|---|---|---|---|
| | | | | | | | | Number density | | Surface | Surface |
| | | Alloy | | | | | | of intermetallic | | closer to | closer to |
| | | | Skin | Skin | Skin | Skin | | compound | Core | skin | skin |
| | | Core | material | material | material | material | | (×10⁶ is omitted) | material | material | material |
| | No. | material | 1 | 2 | 3 | 4 | Step | [particles/mm²] | surface | 1 | 2 |
| Present | 1 | A1 | B1 | D1 | C1 | — | E1 | 7.2 | — | ∘ | — |
| Disclosure | 2 | A2 | B2 | D2 | C2 | — | E1 | 11.5 | — | ∘ | — |
| Examples | 3 | A3 | B3 | D3 | C3 | — | E1 | 1.2 | — | ∘ | — |
| | 4 | A4 | B4 | D4 | C4 | — | E1 | 2.0 | — | ∘ | — |
| | 5 | A5 | B5 | D5 | C5 | — | E1 | 9.4 | — | ∘ | — |
| | 6 | A6 | B6 | D6 | C6 | — | E1 | 1.5 | — | ∘ | — |
| | 7 | A7 | B7 | D7 | C1 | — | E1 | 9.8 | — | ∘ | — |
| | 8 | A8 | B8 | D8 | C2 | — | E1 | 7.8 | — | ∘ | — |
| | 9 | A9 | B9 | D9 | C3 | — | E1 | 7.2 | — | ∘ | — |
| | 10 | A10 | B10 | — | C4 | — | E1 | 7.3 | — | ∘ | — |
| | 11 | A11 | B11 | — | C5 | — | E1 | 6.4 | — | ∘ | — |
| | 12 | A12 | — | — | — | — | E1 | 6.2 | ∘ | — | — |
| | 13 | A1 | B1 | B1 | — | — | E1 | 7.6 | — | ∘ | ∘ |
| | 14 | A1 | B1 | D1 | D1 | B1 | E1 | 7.3 | — | ∘ | — |
| | 15 | A13 | — | — | — | — | E1 | 6.5 | ∘ | — | — |
| | 16 | A14 | B2 | D2 | C2 | — | E1 | 10.8 | — | ∘ | — |
| | 17 | A15 | B3 | D3 | C3 | — | E1 | 1.3 | — | ∘ | — |
| | 18 | A16 | B4 | D4 | C4 | — | E1 | 2.3 | — | ∘ | — |
| | 19 | A17 | B5 | D5 | C5 | — | E1 | 8.9 | — | ∘ | — |
| | 20 | A18 | B6 | D6 | C6 | — | E1 | 1.1 | — | ∘ | — |
| | 21 | A19 | B7 | D7 | C1 | — | E1 | 10.5 | — | ∘ | — |
| | 22 | A20 | B8 | D8 | C2 | — | E1 | 6.3 | — | ∘ | — |
| | 23 | A21 | B9 | D9 | C3 | — | E1 | 6.5 | — | ∘ | — |
| | 24 | A22 | B10 | — | C4 | — | E1 | 6.3 | — | ∘ | — |
| | 25 | A23 | B11 | — | C5 | — | E1 | 7.8 | — | ∘ | — |
| | 26 | A24 | — | — | — | — | E1 | 6.8 | ∘ | — | — |
| | 27 | A14 | B1 | B1 | — | — | E1 | 7.3 | — | ∘ | ∘ |
| | 28 | A14 | B1 | D1 | D1 | B1 | E1 | 6.1 | — | ∘ | — |

| | | Brazability | | | | Corrosion resistance | | | | |
|---|---|---|---|---|---|---|---|---|---|---|
| | | Surface | Surface | | | | Surface | Surface | Surface | Surface |
| | | closer to | closer to | | | | closer to | closer to | closer to | closer to |
| | | skin | skin | | Strength | Core | skin | skin | skin | skin |
| | | material | material | | after | material | material | material | material | material |
| | No. | 3 | 4 | Formability | brazing | surface | 1 | 2 | 3 | 4 |
| Present | 1 | — | — | ∘ | ∘ | — | ∘ | — | ∘ | — |
| Disclosure | 2 | — | — | ∘ | ∘ | — | ∘ | — | ∘ | — |
| Examples | 3 | — | — | ∘ | ∘ | — | ∘ | — | ∘ | — |
| | 4 | — | — | ∘ | ∘ | — | ∘ | — | ∘ | — |
| | 5 | — | — | ∘ | ∘ | — | ∘ | — | ∘ | — |
| | 6 | — | — | ∘ | ∘ | — | ∘ | — | ∘ | — |
| | 7 | — | — | ∘ | ∘ | — | ∘ | — | ∘ | — |
| | 8 | — | — | ∘ | ∘ | — | ∘ | — | ∘ | — |
| | 9 | — | — | ∘ | ∘ | — | ∘ | — | ∘ | — |
| | 10 | — | — | ∘ | ∘ | — | ∘ | — | ∘ | — |
| | 11 | — | — | ∘ | ∘ | — | ∘ | — | ∘ | — |
| | 12 | — | — | ∘ | ∘ | ∘ | — | — | — | — |
| | 13 | — | — | ∘ | ∘ | — | ∘ | ∘ | — | — |
| | 14 | — | ∘ | ∘ | ∘ | — | ∘ | — | — | ∘ |
| | 15 | — | — | ∘ | ∘ | ∘ | — | — | — | — |
| | 16 | — | — | ∘ | ∘ | — | ∘ | — | ∘ | — |
| | 17 | — | — | ∘ | ∘ | — | ∘ | — | ∘ | — |
| | 18 | — | — | ∘ | ∘ | — | ∘ | — | ∘ | — |
| | 19 | — | — | ∘ | ∘ | — | ∘ | — | ∘ | — |
| | 20 | — | — | ∘ | ∘ | — | ∘ | — | ∘ | — |
| | 21 | — | — | ∘ | ∘ | — | ∘ | — | ∘ | — |
| | 22 | — | — | ∘ | ∘ | — | ∘ | — | ∘ | — |
| | 23 | — | — | ∘ | ∘ | — | ∘ | — | ∘ | — |
| | 24 | — | — | ∘ | ∘ | — | ∘ | — | ∘ | — |
| | 25 | — | — | ∘ | ∘ | — | ∘ | — | ∘ | — |
| | 26 | — | — | ∘ | ∘ | ∘ | — | — | — | — |
| | 27 | — | — | ∘ | ∘ | — | ∘ | ∘ | — | — |
| | 28 | — | ∘ | ∘ | ∘ | — | ∘ | — | — | ∘ |

TABLE 7

| | | | | | | | | | Brazability | | |
|---|---|---|---|---|---|---|---|---|---|---|---|
| | | | | | | | | Number density | | Surface | Surface |
| | | Alloy | | | | | | of intermetallic | | closer to | closer to |
| | | | Skin | Skin | Skin | Skin | | compound | Core | skin | skin |
| | | Core | material | material | material | material | | (×10⁶ is omitted) | material | material | material |
| | No. | material | 1 | 2 | 3 | 4 | Step | [particles/mm²] | surface | 1 | 2 |
| Comparative | 29 | A25 | B1 | D1 | C1 | — | E1 | 0.8 | — | x | — |
| Examples | 30 | A26 | B1 | D1 | C1 | — | E1 | 0.9 | — | ∘ | — |
| | 31 | A27 | B1 | D1 | C1 | — | E1 | 10.1 | — | x | — |
| | 32 | A28 | B1 | D1 | C1 | — | E1 | 0.9 | — | ∘ | — |
| | 33 | A29 | B1 | D1 | C1 | — | E1 | 7.6 | — | ∘ | — |
| | 34 | A30 | B1 | D1 | C1 | — | E1 | 7.2 | — | ∘ | — |
| | 35 | A31 | B1 | D1 | C1 | — | E1 | 7.1 | — | ∘ | — |
| | 36 | A32 | — | — | — | — | E1 | 7.6 | ∘ | — | — |
| | 37 | A33 | — | — | — | — | E1 | 7.3 | ∘ | — | — |
| | 38 | A34 | — | — | — | — | E1 | 11.3 | ∘ | — | — |
| | 39 | A35 | B1 | D1 | C1 | — | E1 | 0.7 | — | x | — |
| | 40 | A36 | B1 | D1 | C1 | — | E1 | 0.9 | — | ∘ | — |
| | 41 | A37 | B1 | D1 | C1 | — | E1 | 10.8 | — | x | — |
| | 42 | A38 | B1 | D1 | C1 | — | E1 | 0.8 | — | ∘ | — |
| | 43 | A39 | B1 | D1 | C1 | — | E1 | 6.4 | — | ∘ | — |
| | 44 | A40 | B1 | D1 | C1 | — | E1 | 6.5 | — | ∘ | — |
| | 45 | A41 | B1 | D1 | C1 | — | E1 | 6.4 | — | ∘ | — |
| | 46 | A42 | B1 | D1 | C1 | — | E1 | 7.6 | — | ∘ | — |
| | 47 | A43 | B1 | D1 | C1 | — | E1 | 6.0 | — | ∘ | — |
| | 48 | A44 | — | — | — | — | E1 | 12.1 | ∘ | — | — |
| | 49 | A45 | — | — | — | — | E1 | 6.1 | ∘ | — | — |
| | 50 | A46 | — | — | — | — | E1 | 6.8 | x | — | — |
| | 51 | A1 | B12 | D1 | C1 | — | E1 | 7.9 | — | x | — |
| | 52 | A1 | B13 | D1 | C1 | — | E1 | 6.5 | — | ∘ | — |
| | 53 | A1 | B14 | D1 | C1 | — | E1 | 7.6 | — | ∘ | — |
| | 54 | A1 | B15 | D1 | C1 | — | E1 | 7.3 | — | ∘ | — |
| | 55 | A1 | B16 | D1 | C1 | — | E1 | 7.3 | — | ∘ | — |
| | 56 | A1 | B17 | D1 | C1 | — | E1 | 6.3 | — | ∘ | — |
| | 57 | A1 | B18 | D1 | C1 | — | E1 | 7.1 | — | x | — |
| | 58 | A1 | B19 | D1 | C1 | — | E1 | 7.2 | — | x | — |
| | 59 | A1 | B20 | — | C1 | — | E1 | 6.3 | — | x | — |
| | 60 | A1 | B21 | — | C1 | — | E1 | 6.1 | — | ∘ | — |

| | | Brazability | | | | Corrosion resistance | | | | |
|---|---|---|---|---|---|---|---|---|---|---|
| | | Surface | Surface | | | | Surface | Surface | Surface | Surface |
| | | closer to | closer to | | | | closer to | closer to | closer to | closer to |
| | | skin | skin | | Strength | Core | skin | skin | skin | skin |
| | | material | material | | after | material | material | material | material | material |
| | No. | 3 | 4 | Formability | brazing | surface | 1 | 2 | 3 | 4 |
| Comparative | 29 | — | — | ∘ | x | — | ∘ | — | ∘ | — |
| Examples | 30 | — | — | ∘ | x | — | ∘ | — | ∘ | — |
| | 31 | — | — | ∘ | ∘ | — | x | — | x | — |
| | 32 | — | — | ∘ | x | — | ∘ | — | ∘ | — |
| | 33 | — | — | x | ∘ | — | ∘ | — | ∘ | — |
| | 34 | — | — | x | ∘ | — | ∘ | — | ∘ | — |
| | 35 | — | — | x | ∘ | — | ∘ | — | ∘ | — |
| | 36 | — | — | x | ∘ | ∘ | — | — | — | — |
| | 37 | — | — | x | ∘ | ∘ | — | — | — | — |
| | 38 | — | — | x | ∘ | ∘ | — | — | — | — |
| | 39 | — | — | ∘ | x | — | ∘ | — | ∘ | — |
| | 40 | — | — | ∘ | x | — | ∘ | — | ∘ | — |
| | 41 | — | — | ∘ | ∘ | — | x | — | x | — |
| | 42 | — | — | ∘ | x | — | ∘ | — | ∘ | — |
| | 43 | — | — | x | ∘ | — | ∘ | — | ∘ | — |
| | 44 | — | — | x | ∘ | — | ∘ | — | ∘ | — |
| | 45 | — | — | x | ∘ | — | ∘ | — | ∘ | — |
| | 46 | — | — | x | ∘ | — | ∘ | — | ∘ | — |
| | 47 | — | — | x | ∘ | — | ∘ | — | ∘ | — |
| | 48 | — | — | x | ∘ | ∘ | — | — | — | — |
| | 49 | — | — | ∘ | x | ∘ | — | — | — | — |
| | 50 | — | — | ∘ | ∘ | ∘ | — | — | — | — |
| | 51 | — | — | ∘ | ∘ | — | ∘ | — | ∘ | — |
| | 52 | — | — | x | ∘ | — | ∘ | — | ∘ | — |
| | 53 | — | — | x | ∘ | — | ∘ | — | ∘ | — |
| | 54 | — | — | ∘ | ∘ | — | x | — | ∘ | — |
| | 55 | — | — | x | ∘ | — | ∘ | — | ∘ | — |
| | 56 | — | — | x | ∘ | — | ∘ | — | ∘ | — |
| | 57 | — | — | ∘ | ∘ | — | ∘ | — | ∘ | — |
| | 58 | — | — | ∘ | ∘ | — | ∘ | — | ∘ | — |
| | 59 | — | — | ∘ | ∘ | — | ∘ | — | ∘ | — |
| | 60 | — | — | ∘ | ∘ | — | x | — | ∘ | — |

TABLE 8

| | | | | | | | | | Brazability | | |
|---|---|---|---|---|---|---|---|---|---|---|---|
| | | | | | | | | Number density | | Surface | Surface |
| | | Alloy | | | | | | of intermetallic | | closer to | closer to |
| | | | Skin | Skin | Skin | Skin | | compound | Core | skin | skin |
| | | Core | material | material | material | material | | (×10⁶ is omitted) | material | material | material |
| | No. | material | 1 | 2 | 3 | 4 | Step | [particles/mm²] | surface | 1 | 2 |
| Comparative | 61 | A13 | B12 | D1 | C1 | — | E1 | 6.8 | — | x | — |
| Examples | 62 | A13 | B13 | D1 | C1 | — | E1 | 6.6 | — | ∘ | — |
| | 63 | A13 | B14 | D1 | C1 | — | E1 | 7.6 | — | ∘ | — |
| | 64 | A13 | B15 | D1 | C1 | — | E1 | 6.5 | — | ∘ | — |
| | 65 | A13 | B16 | D1 | C1 | — | E1 | 7.2 | — | ∘ | — |
| | 66 | A13 | B17 | D1 | C1 | — | E1 | 7.0 | — | ∘ | — |
| | 67 | A13 | B18 | D1 | C1 | — | E1 | 6.9 | — | x | — |
| | 68 | A13 | B19 | D1 | C1 | — | E1 | 6.7 | — | x | — |
| | 69 | A13 | B20 | — | C1 | — | E1 | 6.4 | — | x | — |
| | 70 | A13 | B21 | — | C1 | — | E1 | 7.3 | — | ∘ | — |
| | 71 | Al | B1 | D10 | C1 | — | E1 | 7.7 | — | x | — |
| | 72 | A1 | B1 | D11 | C1 | — | E1 | 6.8 | — | ∘ | — |
| | 73 | A1 | B1 | D12 | C1 | — | E1 | 6.6 | — | ∘ | — |
| | 74 | A1 | B1 | D13 | C1 | — | E1 | 7.8 | — | ∘ | — |
| | 75 | A1 | B1 | D14 | C1 | — | E1 | 8.0 | — | ∘ | — |
| | 76 | A1 | B1 | D15 | C1 | — | E1 | 7.4 | — | ∘ | — |
| | 77 | A13 | B1 | D10 | C1 | — | E1 | 6.5 | — | x | — |
| | 78 | A13 | B1 | D11 | C1 | — | E1 | 7.7 | — | ∘ | — |
| | 79 | A13 | B1 | D12 | C1 | — | E1 | 7.6 | — | ∘ | — |
| | 80 | A13 | B1 | D13 | C1 | — | E1 | 7.8 | — | ∘ | — |
| | 81 | A13 | B1 | D14 | C1 | — | E1 | 7.2 | — | ∘ | — |
| | 82 | A13 | B1 | D15 | C1 | — | E1 | 7.6 | — | ∘ | — |
| | 83 | A1 | B1 | D1 | C7 | — | E1 | 7.8 | — | ∘ | — |
| | 84 | A1 | B1 | D1 | C8 | — | E1 | 6.9 | — | ∘ | — |
| | 85 | A13 | B1 | D1 | C7 | — | E1 | 7.9 | — | ∘ | — |
| | 86 | A13 | B1 | D1 | C8 | — | E1 | 6.3 | — | ∘ | — |

| | | Brazability | | | | Corrosion resistance | | | | |
|---|---|---|---|---|---|---|---|---|---|---|
| | | Surface | Surface | | | | Surface | Surface | Surface | Surface |
| | | closer to | closer to | | | | closer to | closer to | closer to | closer to |
| | | skin | skin | | Strength | Core | skin | skin | skin | skin |
| | | material | material | | after | material | material | material | material | material |
| | No. | 3 | 4 | Formability | brazing | surface | 1 | 2 | 3 | 4 |
| Comparative | 61 | — | — | ∘ | ∘ | — | ∘ | — | ∘ | — |
| Examples | 62 | — | — | x | ∘ | — | ∘ | — | ∘ | — |
| | 63 | — | — | x | ∘ | — | ∘ | — | ∘ | — |
| | 64 | — | — | ∘ | ∘ | — | x | — | ∘ | — |
| | 65 | — | — | x | ∘ | — | ∘ | — | ∘ | — |
| | 66 | — | — | x | ∘ | — | ∘ | — | ∘ | — |
| | 67 | — | — | ∘ | ∘ | — | ∘ | — | ∘ | — |
| | 68 | — | — | ∘ | ∘ | — | ∘ | — | ∘ | — |
| | 69 | — | — | ∘ | ∘ | — | ∘ | — | ∘ | — |
| | 70 | — | — | ∘ | ∘ | — | x | — | ∘ | — |
| | 71 | — | — | ∘ | ∘ | — | x | — | ∘ | — |
| | 72 | — | — | x | ∘ | — | ∘ | — | ∘ | — |
| | 73 | — | — | x | ∘ | — | ∘ | — | ∘ | — |
| | 74 | — | — | ∘ | ∘ | — | x | — | ∘ | — |
| | 75 | — | — | x | ∘ | — | ∘ | — | ∘ | — |
| | 76 | — | — | x | ∘ | — | ∘ | — | ∘ | — |
| | 77 | — | — | ∘ | ∘ | — | x | — | ∘ | — |
| | 78 | — | — | x | ∘ | — | ∘ | — | ∘ | — |
| | 79 | — | — | x | ∘ | — | ∘ | — | ∘ | — |
| | 80 | — | — | ∘ | ∘ | — | x | — | ∘ | — |
| | 81 | — | — | x | ∘ | — | ∘ | — | ∘ | — |
| | 82 | — | — | x | ∘ | — | ∘ | — | ∘ | — |
| | 83 | — | — | ∘ | ∘ | — | ∘ | — | x | — |
| | | | | | | | | | (−32 mV) | |
| | 84 | — | — | ∘ | ∘ | — | ∘ | — | x | — |
| | | | | | | | | | (−21 mV) | |
| | 85 | — | — | ∘ | ∘ | — | ∘ | — | x | — |
| | | | | | | | | | (−28 mV) | |
| | 86 | — | — | ∘ | ∘ | — | ∘ | — | x | — |
| | | | | | | | | | (−22 mV) | |

TABLE 9

| | | | | | | | | | Brazability | | |
|---|---|---|---|---|---|---|---|---|---|---|---|
| | | | | | | | | Number density | | Surface | Surface |
| | | Alloy | | | | | | of intermetallic | | closer to | closer to |
| | | | Skin | Skin | Skin | Skin | | compound | Core | skin | skin |
| | | Core | material | material | material | material | | (×10⁶ is omitted) | material | material | material |
| | No. | material | 1 | 2 | 3 | 4 | Step | [particles/mm²] | surface | 1 | 2 |
| Present | 87 | A1 | B1 | — | — | — | E2 | 12.5 | ∘ | ∘ | — |
| Disclosure | 88 | A1 | B1 | — | — | — | E3 | 18.4 | ∘ | ∘ | — |
| Examples | 89 | A13 | B1 | — | — | — | E2 | 12.6 | ∘ | ∘ | — |
| | 90 | A13 | B1 | — | — | — | E3 | 17.3 | ∘ | ∘ | — |
| Comparative | 91 | A1 | B1 | — | — | — | E4 | 0.8 | ∘ | ∘ | — |
| Examples | 92 | A13 | B1 | — | — | — | E4 | 0.9 | ∘ | ∘ | — |

| | | Brazability | | | | Corrosion resistance | | | | |
|---|---|---|---|---|---|---|---|---|---|---|
| | | Surface | Surface | | | | Surface | Surface | Surface | Surface |
| | | closer to | closer to | | | | closer to | closerto | closer to | closer to |
| | | skin | skin | | Strength | Core | skin | skin | skin | skin |
| | | material | material | | after | material | material | material | material | material |
| | No. | 3 | 4 | Formability | brazing | surface | 1 | 2 | 3 | 4 |
| Present | 87 | — | — | ∘ | ∘ | ∘ | ∘ | — | — | — |
| Disclosure | 88 | — | — | ∘ | ∘ | ∘ | ∘ | — | — | — |
| Examples | 89 | — | — | ∘ | ∘ | ∘ | ∘ | — | — | — |
| | 90 | — | — | ∘ | ∘ | ∘ | ∘ | — | — | — |
| Comparative | 91 | — | — | ∘ | x | ∘ | ∘ | — | — | — |
| Examples | 92 | — | — | ∘ | x | ∘ | ∘ | — | — | — |

The results of the subjection of the above-described samples to each of evaluations described below are set forth in Tables 6 to 9.

(Number Density of Al—Cu—Mn-Based Intermetallic Compound)

The number density of an Al—Cu—Mn-based intermetallic compound having an equivalent circle diameter of 0.1 to 1.0 μm was measured by the SEM observation of the sample. The number density of the Al—Cu—Mn-based intermetallic compound before brazing heating was determined by observing the three visual fields of each sample material and performing the image analysis of an SEM image in each visual field with A-ZO-KUN (Asahi Kasei Engineering Corporation). A number density set forth in Tables is the arithmetic mean value of numerical values determined from the three visual fields of each sample.

(Formability)

A JIS No. 5 specimen was cut from each sample. A tensile test in conformity with JIS Z 2241: 2011 was conducted for the specimen. Formability was evaluated as favorable “∘” in the case of an elongation of 2% or more in the test, while formability was evaluated as defective “x” in the case of an elongation of less than 2%.

(Strength after Brazing Heating)

A JIS No. 5 specimen was cut from each sample. The brazing-equivalent heating of the specimen was performed at 600° C. for 3 minutes, followed by performing natural aging at 25° C. for 1 week and conducting a tensile test in conformity with JIS Z 2241: 2011. In the case of a single-layer material with only a core material containing no Mg, a tensile strength of 200 MPa or more was evaluated as favorable “∘”, while a tensile strength of less than 200 MPa was evaluated as defective “x”. In the case of a clad material with a core material containing no Mg, a tensile strength of 180 MPa or more was evaluated as favorable “∘”, while a tensile strength of less than 180 MPa was evaluated as defective “x”. In contrast, in the case of a single-layer material with only a core material containing Mg, a tensile strength of 270 MPa or more was evaluated as favorable “∘”, while a tensile strength of less than 270 MPa was evaluated as defective “x”. In the case of a clad material with a core material containing Mg, a tensile strength of 250 MPa or more was evaluated as favorable “∘”, while a tensile strength of less than 250 MPa was evaluated as defective “x”.

(Brazability)

A bare material with only a core material, which had a thickness of 0.07 mm and refining H14 and in which a core material alloy component was a component in which 1.0% of Zn was added to a 3003 alloy, or a clad material of which both surfaces were clad with an A4045 alloy at 10% was prepared as a fin material, and such fin materials were corrugated to form heat exchanger fins. Among the samples described above, the bare material with only the core material in combination with the fin of the clad material and the other materials in combination with the fin of the bare material on a brazing filler material surface were immersed in 5% fluoride flux aqueous suspension and subjected to brazing heating at 600° C. for 3 minutes to produce mini-core samples. In a case in which the fin bonding ratio of such a mini-core sample was 95% or more, and neither the sample nor the fin was melted, brazability was evaluated as favorable (∘). In contrast, in both (1) a case in which the fin bonding ratio was less than 95% and (2) a case in which at least any one of the sample and the fin was melted, or in either (1) or (2), brazability was evaluated as defective (x).

(Evaluation of Internal Corrosion Resistance)

The evaluation of internal corrosion resistance on a surface of a sacrificial anode material or a surface of a brazing filler material clad on an intermediate layer material was performed. The evaluation of the internal corrosion resistance was performed for the samples in Embodiments 2 to 4 of the second disclosure. In each test, a single sheet, which was subjected to brazing-equivalent heating at 600° C. for 3 minutes, and of which a surface, not targeted for the evaluation, was masked with an insulating resin, was used as a corrosiveness test sample. A circulation cycle test simulating a water-based refrigerant environment was conducted for the sample. An aqueous solution containing 195 ppm of Cl⁻, 60 ppm of SO₄²⁻, 1 ppm of Cu²⁺, and 30 ppm of Fe²⁺ at a temperature of 88° C. was allowed to flow on a test surface of the specimen of each sample at a solution volume to specimen area ratio of 6 mL/Cm² and a flow rate of 2 m/s for 8 hours, and the specimen was then left standing for 16 hours. Such a cycle including heating flowing and leaving was performed for 3 months. After the circulation cycle test, a corrosion product on a specimen surface was removed, and the depth of corrosion was measured. The maximum value of values at ten measurement spots per specimen was regarded as the depth of corrosion. A case in which the depth of corrosion was 90 μm or less was evaluated as “∘” (favorable), while a case in which the depth of corrosion was more than 90 μm, a case in which penetration occurred, and a case in which intergranular corrosion was observed were evaluated as “x” (defective). In the case in which the depth of corrosion is more than 90 μm, a potential difference between a core material and a sacrificial anode material surface (core material-sacrificial anode material) was described together.

(Evaluation of External Corrosion Resistance)

The external corrosion resistance was evaluated for a surface of a core material and a surface of a brazing filler material clad on the core material. The evaluation of the external corrosion resistance was performed for the samples of the first disclosure and Embodiment 1 of the second disclosure. In a manner similar to the manner of the evaluation of the brazability, a bare material with only a core material, which had a thickness of 0.07 mm and refining H14 and in which a core material alloy component was a component in which 1.0% of Zn was added to a 3003 alloy, or a clad material of which both surfaces were clad with a 4045 alloy at 10% was prepared as a fin material, and such fin materials were corrugated to form heat exchanger fins. Among the materials described above, a combination of the core material surface and a clad fin, and a combination of the brazing filler material surface and a bare fin were immersed in 5% fluoride flux aqueous suspension and subjected to brazing heating at 600° C. for 3 minutes to produce mini-core samples. The samples were subjected to a CASS test for 500 hours on the basis of JIS-H8502. As a result, a case in which penetration did not occur in an evaluation material after 500 hours was evaluated as “∘” (acceptable), while a case in which the penetration occurred, and a case in which intergranular corrosion was observed were evaluated as “x” (unacceptable).

In Present Disclosure Examples 1 to 28, and 87 to 90, the conditions set in the present disclosure were satisfied, and all of brazability, formability, strength after brazing, and corrosion resistance were acceptable.

In contrast, in Comparative Examples 29 and 39, the content of Si in the core material was too large, the number density of the Al—Cu—Mn-based intermetallic compound in the core material was therefore decreased, and strength after brazing was unacceptable. In addition, the solidus-line temperature of the core material was decreased, and brazability was unacceptable.

In Comparative Examples 30 and 40, the content of Cu in the core material was too small, the number density of the Al—Cu—Mn-based intermetallic compound in the core material was therefore decreased, and strength after brazing was unacceptable.

In Comparative Examples 31 and 41, the content of Cu in the core material was too large, the solidus-line temperature of the core material was therefore decreased, and brazability was unacceptable. In addition, susceptibility to intergranular attack was improved, and internal corrosion resistance was unacceptable.

In Comparative Examples 32 and 42, the content of Mn in the core material was too small, the number density of the Al—Cu—Mn-based intermetallic compound in the core material is therefore decreased, and strength after brazing was unacceptable.

In Comparative Examples 33 to 38, and 43 to 48, the contents of Mn, Ti, Zr, Cr, and V in the core material were too large, a coarse intermetallic compound was therefore generated in casting, and formability was unacceptable.

In Comparative Example 49, the content of Mg in the core material was too small, and brazing strength was therefore unacceptable.

In Comparative Example 50, the content of Mg in the core material was too large, and brazability was therefore unacceptable.

In Comparative Examples 51 and 61, the content of Si in the brazing filler material was too small, and brazability was therefore unacceptable.

In Comparative Examples 52 and 62, the content of Si in the brazing filler material was too large, a coarse intermetallic compound was therefore generated in the brazing filler material, and formability was unacceptable.

In Comparative Examples 53 and 63, the content of Fe in the brazing filler material was too large, a coarse intermetallic compound was therefore generated in the brazing filler material, and formability was unacceptable.

In Comparative Examples 54 and 64, the content of Cu in the brazing filler material was too large, the potential of the brazing filler material therefore became high, and internal corrosion resistance was unacceptable.

In Comparative Examples 55 and 65, the content of Mn in the brazing filler material was too large, a coarse intermetallic compound was therefore generated in the brazing filler material, and formability was unacceptable.

In Comparative Examples 56 and 66, the contents of Ti, Zr, Cr, and V in the brazing filler material were too large, a coarse intermetallic compound was therefore generated in casting, and formability was unacceptable.

In Comparative Examples 57, 59, 67, and 69, the content of Na in the brazing filler material was too large, the thickness of an oxide film on a surface of the brazing filler material was therefore increased, and brazability was unacceptable.

In Comparative Examples 58, 59, 68, and 69, the content of Sr in the brazing filler material was too large, the thickness of an oxide film on a surface of the brazing filler material was therefore increased, and brazability was unacceptable.

In Comparative Examples 60 and 70, the content of Zn in the brazing filler material was too large, a corrosion rate was therefore increased, and internal corrosion resistance was unacceptable.

In Comparative Examples 71 and 77, the content of Si in the intermediate layer material was too large, the potential of the intermediate layer therefore became too high, and internal corrosion resistance was unacceptable. In addition, the solidus-line temperature of the intermediate layer material was decreased, and brazability was unacceptable.

In Comparative Examples 72 and 78, the content of Fe in the intermediate layer material was too large, a coarse intermetallic compound was therefore generated in casting, and formability was unacceptable.

In Comparative Examples 73 and 79, the contents of Ti, Zr, Cr, and V in the intermediate layer material were too large, a coarse intermetallic compound was therefore generated in casting, and formability was unacceptable.

In Comparative Examples 74 and 80, the content of Zn in the intermediate layer material was too large, a corrosion rate was therefore increased, and internal corrosion resistance was unacceptable.

In Comparative Examples 75 and 81, the content of Ni in the intermediate layer material was too large, a coarse intermetallic compound was therefore generated in casting, and formability was unacceptable.

In Comparative Examples 76 and 82, the content of Mn in the intermediate layer material was too large, a coarse intermetallic compound was therefore generated in casting, and formability was unacceptable.

In Comparative Examples 83 to 86, the potential of the sacrificial anode material was higher than that of the core material, and internal corrosion resistance was therefore unacceptable.

In Comparative Examples 91 and 92, a rolling reduction ratio was too low in a case in which the hot-rolled material was at 500 to 400° C., the number density of the Al—Cu—Mn-based intermetallic compound was therefore decreased, and strength after brazing was unacceptable.

### INDUSTRIAL APPLICABILITY

According to the present disclosure, there can be obtained an aluminum alloy material and an aluminum alloy clad material provided with high strength by precipitation strengthening and solid solution strengthening after brazing heating due to the definition of the state of the presence of an Al—Cu—Mn-based intermetallic compound.

### REFERENCE SIGNS LIST

1 Tube
2 Fin
3 Header
4 Tank

1. An aluminum alloy material for a heat exchanger, comprising an aluminum alloy comprising 0.02 to 0.40 mass % Si, 1.0 to 2.5 mass % Cu, 0.5 to 2.0 mass % Mn, and a balance of Al and inevitable impurities, wherein a number density of an Al—Cu—Mn-based intermetallic compound having an equivalent circle diameter of 0.1 to 1.0 μm is 1.0×10⁶/mm² or more.

2. The aluminum alloy material for a heat exchanger according to claim 1, wherein the aluminum alloy further comprises one or more selected from 0.1 to 1.0 mass % Mg, 0.05 to 0.20 mass % Ti, 0.05 to 0.20 mass % V, 0.05 to 0.20 mass % Zr, and 0.05 to 0.20 mass % Cr.

3. A method for producing the aluminum alloy material for a heat exchanger according to claim 1, the method comprising a casting step of casting the aluminum alloy, a hot-rolling step of hot-rolling a cast ingot, a cold-rolling step of cold-rolling a hot-rolled sheet, and one or more annealing steps of annealing a cold-rolled sheet during or after the cold-rolling step, or during and after the cold-rolling step, wherein a sheet thickness reduction ratio in a case in which a temperature of the hot-rolled sheet is in a temperature range of 500 to 400° C. is 90% or more in the hot-rolling step.

4. An aluminum alloy clad material for a heat exchanger, comprising: a core material of an aluminum alloy; and a brazing filler material clad on one surface or both surfaces of the core material, wherein the core material comprises an aluminum alloy comprising 0.02 to 0.40 mass % Si, 1.0 to 2.5 mass % Cu, 0.5 to 2.0 mass % Mn, and a balance of Al and inevitable impurities; the brazing filler material comprises an aluminum alloy comprising 2.5 to 12.5 mass % Si, 0.05 to 1.20 mass % Fe, and a balance of Al and inevitable impurities; and a number density of an Al—Cu—Mn-based intermetallic compound having an equivalent circle diameter of 0.1 to 1.0 μm in the core material is 1.0×10⁶/mm² or more.

5. The aluminum alloy clad material for a heat exchanger according to claim 4, wherein the core material further comprises one or more selected from 0.1 to 1.0 mass % Mg, 0.05 to 0.20 mass % Ti, 0.05 to 0.20 mass % V, 0.05 to 0.20 mass % Zr, and 0.05 to 0.20 mass % Cr.

6. The aluminum alloy clad material for a heat exchanger according to claim 4, wherein the brazing filler material comprises an aluminum alloy further comprising one or more selected from 0.5 to 8.0 mass % Zn, 0.05 to 2.50 mass % Cu, 0.05 to 2.00 mass % Mn, 0.05 to 0.20 mass % Ti, 0.05 to 0.20 mass % Zr, 0.05 to 0.20 mass % Cr, and 0.05 to 0.20 mass % V.

7. The aluminum alloy clad material for a heat exchanger according to claim 4, wherein the brazing filler material comprises an aluminum alloy further comprising one or two selected from 0.001 to 0.050 mass % Na and 0.001 to 0.050 mass % Sr.

8. A method for producing the aluminum alloy clad material for a heat exchanger according to claim 4, the method comprising: a casting step of casting each of the aluminum alloy for the core material and the aluminum alloy for the brazing filler material; a hot-rolling step of hot-rolling a cast brazing filler material ingot to have a predetermined thickness; a cladding step of cladding the brazing filler material allowed to have the predetermined thickness by the hot rolling on one surface or both surfaces of a core material ingot; a hot clad rolling step of hot-rolling the clad material; a cold-rolling step of cold-rolling the hot-clad-rolled clad material; and one or more annealing steps of annealing the clad material during or after the cold-rolling step, or during and after the cold-rolling step, wherein a sheet thickness reduction ratio in a case in which a temperature of the clad material is in a temperature range of 500 to 400° C. is 90% or more in the hot clad rolling step.

9. An aluminum alloy clad material for a heat exchanger, comprising: a core material of an aluminum alloy; a brazing filler material clad on one surface of the core material; and a sacrificial anode material clad on another surface, wherein the core material comprises an aluminum alloy comprising 0.02 to 0.40 mass % Si, 1.0 to 2.5 mass % Cu, 0.5 to 2.0 mass % Mn, and a balance of Al and inevitable impurities; the brazing filler material comprises an aluminum alloy comprising 2.5 to 12.5 mass % Si, 0.05 to 1.20 mass % Fe, and a balance of Al and inevitable impurities; the sacrificial anode material comprises an aluminum alloy of which a natural potential is lower than that of the core material after brazing-equivalent heating at 600° C. for 3 minutes; and a number density of an Al—Cu—Mn-based intermetallic compound having an equivalent circle diameter of 0.1 to 1.0 μm in the core material is 1.0×10⁶/mm² or more.

10. The aluminum alloy clad material for a heat exchanger according to claim 9, wherein the core material further comprises one or more selected from 0.1 to 1.0 mass % Mg, 0.05 to 0.20 mass % Ti, 0.05 to 0.20 mass % V, 0.05 to 0.20 mass % Zr, and 0.05 to 0.20 mass % Cr.

11. The aluminum alloy clad material for a heat exchanger according to claim 9, wherein the brazing filler material comprises an aluminum alloy further comprising one or more selected from 0.5 to 8.0 mass % Zn, 0.05 to 2.50 mass % Cu, 0.05 to 2.00 mass % Mn, 0.05 to 0.20 mass % Ti, 0.05 to 0.20 mass % Zr, 0.05 to 0.20 mass % Cr, and 0.05 to 0.20 mass % V.

12. The aluminum alloy clad material for a heat exchanger according to claim 9, wherein the brazing filler material comprises an aluminum alloy further comprising one or two selected from 0.001 to 0.050 mass % Na and 0.001 to 0.050 mass % Sr.

13. A method for producing the aluminum alloy clad material for a heat exchanger according to claim 9, the method comprising: a casting step of casting each of the aluminum alloy for the core material, the aluminum alloy for the brazing filler material, and the aluminum alloy for the sacrificial anode material; a hot-rolling step of hot-rolling each of a cast brazing filler material ingot and a cast sacrificial anode material ingot to have a predetermined thickness; a cladding step of cladding the brazing filler material allowed to have the predetermined thickness by the hot rolling on one surface of a core material ingot and cladding the sacrificial anode material allowed to have the predetermined thickness by the hot rolling on another surface of the core material ingot; a hot clad rolling step of hot-rolling the clad materials; a cold-rolling step of cold-rolling the hot-clad-rolled clad materials; and one or more annealing steps of annealing a cold-rolled sheet during or after the cold-rolling step, or during and after the cold-rolling step, wherein a sheet thickness reduction ratio in a case in which temperatures of the clad materials are in a temperature range of 500 to 400° C. is 90% or more in the hot clad rolling step.

14. The aluminum alloy clad material for a heat exchanger according to claim 4, wherein an intermediate layer material is further clad between the core material and the brazing filler material clad on one surface or both surfaces of the core material, and the intermediate layer material comprises an aluminum alloy comprising 0.5 to 8.0 mass % Zn, 0.05 to 1.50 mass % Si, 0.05 to 2.00 mass % Fe, and a balance of Al and inevitable impurities.

15. The aluminum alloy clad material for a heat exchanger according to claim 9, wherein an intermediate layer material is further clad between the core material and the brazing filler material clad on one surface of the core material, and the intermediate layer material comprises an aluminum alloy comprising 0.5 to 8.0 mass % Zn, 0.05 to 1.50 mass % Si, 0.05 to 2.00 mass % Fe, and a balance of Al and inevitable impurities.

16. The aluminum alloy clad material for a heat exchanger according to claim 14, wherein the intermediate layer material comprises an aluminum alloy further comprising one or more selected from 0.05 to 2.00 mass % Mn, 0.05 to 2.00 mass % Ni, 0.05 to 0.20 mass % Ti, 0.05 to 0.20 mass % Zr, 0.05 to 0.20 mass % Cr, and 0.05 to 0.20 mass % V.

17. A method for producing the aluminum alloy clad material for a heat exchanger according to claim 14, the method comprising: a casting step of casting each of the aluminum alloy for the core material, the aluminum alloy for the brazing filler material, and the aluminum alloy for the intermediate layer material; a hot-rolling step of hot-rolling each of a cast brazing filler material ingot and a cast intermediate layer material ingot to have a predetermined thickness; a cladding step of cladding the intermediate layer material allowed to have the predetermined thickness by the hot rolling on one surface or both surfaces of a core material ingot and cladding the brazing filler material allowed to have the predetermined thickness by the hot rolling on a surface, which is not closer to the core material, of the clad intermediate layer material; a hot clad rolling step of hot-rolling the clad materials; a cold-rolling step of cold-rolling the hot-clad-rolled clad materials; and one or more annealing steps of annealing the clad materials during or after the cold-rolling step, or during and after the cold-rolling step, wherein a sheet thickness reduction ratio in a case in which temperatures of the clad materials are in a temperature range of 500 to 400° C. is 90% or more in the hot clad rolling step.

18. A method for producing the aluminum alloy clad material for a heat exchanger according to claim 15, the method comprising: a casting step of casting each of the aluminum alloy for the core material, the aluminum alloy for the brazing filler material, the aluminum alloy for the sacrificial anode material, and the aluminum alloy for the intermediate layer material; a hot-rolling step of hot-rolling each of a cast brazing filler material ingot, a cast sacrificial anode material ingot, and a cast intermediate layer material ingot to have a predetermined thickness; a cladding step of cladding the intermediate layer material allowed to have the predetermined thickness by the hot rolling on one surface of a core material ingot, cladding the brazing filler material allowed to have the predetermined thickness by the hot rolling on a surface, which is not closer to the core material, of the clad intermediate layer material, and cladding the sacrificial anode material allowed to have the predetermined thickness by the hot rolling on the other surface of the core material ingot; a hot clad rolling step of hot-rolling the clad materials; a cold-rolling step of cold-rolling the hot-clad-rolled clad materials; and one or more annealing steps of annealing the clad materials during or after the cold-rolling step, or during and after the cold-rolling step, wherein a sheet thickness reduction ratio in a case in which temperatures of the clad materials are in a temperature range of 500 to 400° C. is 90% or more in the hot clad rolling step.
